(19) United States
(12) Patent Application Publication
(10) Pub. No.: US 2011/0103575 A1
(43) Pub. Date: May 5, 2011

(54) HIGH-DENSITY SPLITTER/PATCH TELECOMMUNICATIONS SYSTEM

(75) Inventors: Paul A. Knight, Spokane, WA (US); Karch Polgar, Elk, WA (US)

(73) Assignee: Telect Inc., Liberty Lake, WA (US)

(21) Appl. No.: 12/609,921

(22) Filed: Oct. 30, 2009

(51) Int. Cl. H04M 1/00

(52) U.S. Cl. 379/413.04

(57) ABSTRACT

A high-density telecommunications patch/splitter system to allow a user to access multiple adapters disposed on even high-density splitter modules and odd high-density splitter modules. The even high-density splitter modules have an even adapter array and the odd high-density splitter modules have an odd adapter array that, when installed in the chassis, allow a user access to the adapters.

### TECHNICAL FIELD

This application relates to telecommunications modules and chassis, and particularly to modules and chassis for high-density telecommunications patch/splitter systems.

### BACKGROUND

As opposed to directly hard-wiring telecommunications equipment, high-density optical distribution frames allow connected equipment to terminate at one or more central locations. This allows for easier adding, removing or rearranging of optical connections among the equipment. High-density optical distribution frames also offer the ability to test, monitor and repair equipment that is terminated at the telecommunications central location.

A central telecommunications location typically includes one or more telecommunications racks, which are referred to as bays when populated with telecommunications equipment. Racks are designed to hold one or more chassis, panels, terminal strips, terminal blocks and/or test and maintenance equipment. Conventional chassis may be either modular or non-modular. A non-modular chassis is built and delivered fully populated with the maximum number of optical signals the chassis is designed to seat. In a modular chassis, splitter modules may be inserted into and removed from a chassis depending on whether a user wishes to increase or reduce the number of optical signals in the modular chassis. Each splitter module includes a number of optical signals. A modular chassis offers the benefit of greater customization, as individual splitter modules can be purchased when additional optical signals are desired.

Traditional modular chassis have accommodated a relatively small number of modules (and therefore optical signals) due to the size of the conventional modules and the limited width available in standard rack installations.

### SUMMARY

A high-density telecommunications patch/splitter system is provided to allow for a high-density installation of a plurality of high-density modules in a high-density telecommunications chassis. In one example, each of the modules is coupled to the chassis at the front surface of the modules, and each of the modules includes a pin protruding from the back surface of the modules configured to be engaged by a stabilizer. The stabilizer is coupled to a back of the chassis and engages the pin protruding from the back surface of each module to stabilize the modules in the chassis.

In another example, a high-density telecommunications splitter module may include a module housing with a front surface and a back surface opposite the front surface. The front surface comprises a top edge and a bottom edge located opposite the top edge, and an adapter array disposed vertically on the front surface and offcenter toward either the top edge or the bottom edge. The high-density splitter module may also have front surface couplings for coupling the splitter module front surface to a front surface of a high-density telecommunications chassis.

In another example, a high-density splitter modules may comprise an odd high-density module or an even high-density module. Each odd high-density module is configured to install in the high-density telecommunications chassis and to be securely positioned directly adjacent to an even high-density module in the chassis, which defines a mated pair. When the even high-density module is securely positioned directly adjacent to the odd high-density module in the chassis, adapters on the odd high-density module are offset relative to adapters on the even high-density module, so as to provide clearance to grasp the adapters.

In yet another example, a user may choose to populate a high-density telecommunications chassis with individual even and odd high-density splitter modules, with a mated pair, with an array of mated pairs, and/or with high-density patching modules such that any adapter disposed on any of the modules is accessible to a user by virtue of the adapter positioning. In addition, a new adapter orientation is provided to accommodate a narrow front surface of the modules.

### BRIEF DESCRIPTION OF THE DRAWINGS

The detailed description is described with reference to the accompanying figures. The use of the same reference numbers in different figures indicates similar or identical items.

FIG. 1 illustrates an exemplary environment for a telecommunications system.

FIG. 2 shows an exemplary telecommunications rack populated with multiple chassis including low-density telecommunications chassis, and high-density telecommunications chassis. The high-density chassis are populated with mated pairs of splitter modules, an array of mated pairs of splitter modules, and high-density patching modules.

FIG. 3 shows a populated low-density modular chassis alongside a high-density modular chassis.

FIG. 4A shows an exemplary implementation of a high-density telecommunications chassis of the present disclosure, including an exemplary implementation of a stabilizer.

FIG. 4B shows an exemplary stabilizer used to support modules when installed in the high-density chassis of FIG. 4A.

FIG. 5 is a perspective view of a high-density splitter module.

FIG. 6 shows perspective views of an exemplary implementation of even and odd high-density splitter modules of the present disclosure.

FIG. 7 shows an exemplary implementation of a mated pair of the even and odd high-density splitter modules of FIG. 6.

FIG. 8 shows the mated pair of FIG. 7 and a neighboring array of mated pairs installed in the high-density telecommunications chassis of FIG. 4 in more detail.

FIG. 9 shows the mated pair of FIG. 7, the neighboring array of mated pairs of FIG. 8, and an array of high-density patching modules installed in the high-density telecommunications chassis of FIG. 4.

FIG. 10 is a flow diagram that illustrates an exemplary process of using a high-density telecommunications patch/splitter system.

### DETAILED DESCRIPTION

This disclosure is directed to techniques for installing modules in a high-density telecommunications chassis. In some implementations, the modules include even high-density splitter modules, odd high-density splitter modules and high-density patching modules.

Traditionally, splitter modules have been configured to accommodate six adapters disposed on a front surface of each module. Traditional modules have been about 1.15 inches wide and, as such, a traditional nineteen inch modular chassis is configured to receive twelve splitter modules. These splitter modules may be secured in position by different techniques, including the use of standard plastic push button fasteners. When a splitter module is secured in position, the module is positioned in the chassis in a secured manner and provides enough support to keep the splitter module secure for the user.

As discussed above, traditional splitter module chassis have accommodated a relatively small number of splitter modules and, therefore, optical signals for a given space. Accordingly, this disclosure describes techniques for providing a substantially greater number of splitter modules, and therefore optical signals, for a given space than was previously possible. To achieve these higher numbers of splitter modules, this application describes high-density splitter modules having a width of at most about 0.6 inches. In some implementations, the splitter modules described herein have a width of about 0.5 inches. Because these high-density splitter modules are relatively narrow, conventional fasteners used to secure splitter modules to the chassis do not securely and stably mount the modules in the chassis. This can be problematic.

The high-density telecommunications chassis of the present disclosure allows a larger number of modules to be installed in a given space than previous low-density chassis, while still allowing sufficient clearance to access multiple adapters. Moreover, the present disclosure describes techniques for securely mounting relatively narrow high-density splitter modules. The techniques are described in the context of a fiber optic connectivity telecommunications environment. However, the described techniques can be implemented in a multitude of other contexts, such as a copper-based connectivity telecommunications environment.

### Exemplary Environment

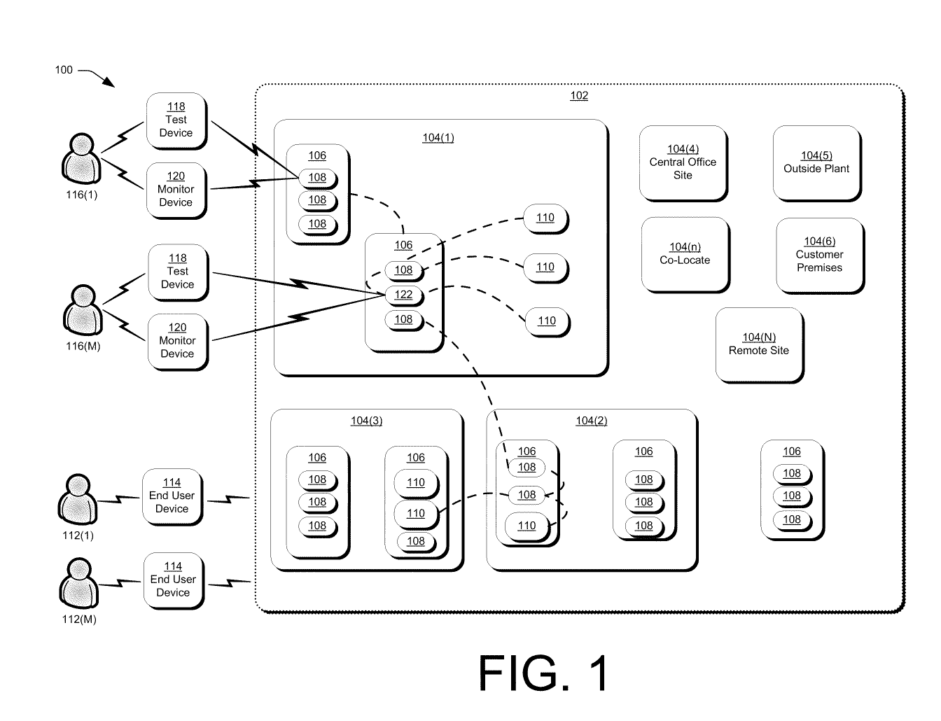

FIG. 1 illustrates an exemplary implementation of an environment 100 operable to provide a telecommunications network in which the apparatuses and procedures of the present disclosure may be employed. The environment 100 includes at least a portion of a telecommunication network infrastructure 102 (hereinafter “infrastructure”) Infrastructure 102 provides telecommunications processes, structures, equipment and devices between end-user devices such as modems, phones, facsimile devices, and so on used by end-users outside of the infrastructure 102 to communicate via a telecommunications network. Within infrastructure 102 a variety of equipment, apparatus and devices are utilized in routing, processing, and distributing signals. Telecommunications signals and data may be processed, switched, routed, tested, patched, managed, or distributed by various equipment in the infrastructure 102. Infrastructure 102 may include fiber, copper and or other types of communication cabling and transmission media utilized in routing, processing, and distributing telecommunications signals.

A variety of sites 104(1)-104(N) within infrastructure 102 may maintain various equipment used in the infrastructure 102. As depicted in FIG. 1, infrastructure 102 may have numerous sites 104 which may be different physical locations within infrastructure 102 such as a central office, an outside plant site, a co-locate site, a remote site, or customer premises. Sites 104 may be locations within infrastructure 102 which hold a variety of structures and equipment to facilitate processing and distributing of telecommunications signals. The equipment may be centralized in one site (e.g., site 104(1)) or dispersed throughout different sites 104 in infrastructure 102. In other words, interconnections may be made between various sites 104 in infrastructure 102, as shown, for example, by the connection denoted in FIG. 1 by a dashed line between site 104(1) and 104(2). Naturally, numerous interconnections between a plurality of sites 104 may be made.

Each site 104 may have one or more housings 106 having a plurality of components 108. A housing 106 may be configured in a variety of ways to maintain or hold a plurality of components 108 in infrastructure 102. For example, a housing 106 may be configured as a housing for a cabinet, a terminal block, a panel, a chassis, a digital cross-connect, a switch, a hub, a rack, a frame, a bay, a module, an enclosure, an aisle, or other structure for receiving and holding a plurality of components 108. Hereinafter, the terms housing and cabinet will be used for convenience to refer to the variety of structures in infrastructure 102 that may hold components 108.

Housing 106 may be situated in a variety of locations, such as inside a building or placed outside. Housings 106, for example, may be configured to protect components 108 from environmental influences when inside or outside. FIG. 1, for instance, depicts site 104(1) as having two housings (e.g., cabinets) 106, each having a plurality of components 108. Other housings 106 may be included throughout infrastructure 102 at sites 104 as shown, for example, by housings 106 depicted within site 104(2).

Components 108 are pieces of telecommunications equipment in infrastructure 102 that may be kept or maintained in a housing 106 (e.g. cabinet) within the infrastructure 102. Components, for example, may be cross-connect panels, modules, splitters, combiners, terminal blocks, chassis, backplanes, switches, digital radios, repeaters and so forth. Generally, components 108 may be those devices utilized for processing and distributing signals in infrastructure 102 and which may be maintained in a housing 104. Components 108 may terminate, interconnect or cross-connect a plurality of network elements 110 within infrastructure 102. For example, components 108 may be utilized to distribute telecommunications signals sent to and from infrastructure 102 by one or more end-users 112 using an end-user device 114. The interconnections between telecommunications equipment (e.g. cabinets 106, components 108 and network elements 110) provide signal pathways for telecommunications signals (e.g., optical signals, electrical signals, digital signals, and/or analog signals). Interconnection may be via one or more components 108, such as by adapters on a module, connectors on a module, or may be internal to the components 108, such as via a printed circuit board within a component 108. Representative interconnections are shown by dashed lines in FIG. 1 and numerous interconnections within and between telecommunication equipment are typical.

Network elements 110 may be implemented in a variety of ways. For example, network elements 110 may be configured as fiber optic equipment, switches, digital cross connect (DCX) systems, telecommunication panels, terminal blocks, digital radios, network office terminating equipment, and any other telecommunication equipment or devices employed in a telecommunications infrastructure 102. It is noted that one or more of the components 108 within a cabinet 106 may also be a network element 110. In other words, network elements 110 may be found within a cabinet 106 as a component 108 of the cabinet. Thus, in a particular cabinet 106 interconnections may be between network elements 110 externally (e.g., not in the same cabinet) or internally (e.g., within the same cabinet). Naturally, internal and external interconnections may be mixed, such that a single cabinet 106 will have both internal and external interconnections. Further, such connections for a particular cabinet 106 might be made wholly within a particular site 104 and/or between a plurality of sites 104.

The environment 100 depicts a plurality of end users 112(1)-112(M) which may be communicatively coupled, one to another, via a telecommunication network including infrastructure 102. End users 112 may refer to a variety of users, such as consumers, business users, internal users in a private network, and other types of users that use telecommunications signals or transmit and receive telecommunications signals via client devices. Additionally, for purposes of the following discussion clients 112(1)-112(M) may also refer to the client devices and software which are operable to transmit and receive telecommunications signals. Thus, clients 112(1)-112(M) may be implemented as users, software and/or devices.

The environment 100 further depicts a plurality of users 116(1)-116(M) which may be monitoring and testing the telecommunications signals. Users 116 may refer to a variety of provider users, such as engineers, installation technicians, test technicians, maintenance technicians, service technicians, administrators, internal providers in a private network, and other types of provider users that monitor and test telecommunications signals. Additionally, for purposes of the following discussion, users 116(1)-116(M) may also refer to devices and software which are operable to monitor and test telecommunications signals. Thus, users 116(1)-116(M) may be implemented as providers, software and/or devices.

The interconnection of pieces of equipment (e.g. cabinets 106, components 108 and network elements 110, and so forth) provides signal pathways between equipment for signals input to and output from infrastructure 102. For example, end-users 112(1)-112(M) may send signals into the infrastructure 102 and receive signals output from the infrastructure using a variety of end user devices 114. End user 112(1), for instance, may communicate with end user 112(M) via end-user device 114 (e.g., a telephone). Thus, signals sent to and from infrastructure by end-users 112 via an end user device 114 may be routed directed, processed, and distributed in a variety of ways via the equipment and interconnections within infrastructure 102.

Additionally, users 116(1)-116(M) may monitor and test the signal pathways between equipment of the interconnected pieces of equipment (e.g. cabinets 106, components 108 and network elements 110, and so forth). For example, users 116(1)-116(M) may monitor and test the signal pathways between equipment at component 108 of cabinet 106 using a variety of provider devices, such as test device 118 and monitor device 120. The test and monitor devices may include any combination of known optical and/or electrical multi-meters for testing and/or monitoring characteristics of the network (e.g., connectivity, signal strength, bandwidth, etc.). User 116(1), for instance, may monitor and test the signal pathway between housings 106 in site 104(1) via devices 118 and 120. Thus, signals sent to and from infrastructure by end-users 112 via an end user device 114 may be routed directed, processed, and distributed in a variety of ways via the equipment and interconnections within infrastructure 102. Additionally, user 116 may monitor and test the signal pathways between equipment of the interconnected pieces of equipment via devices 118 and 120.

### Telecommunications Bay

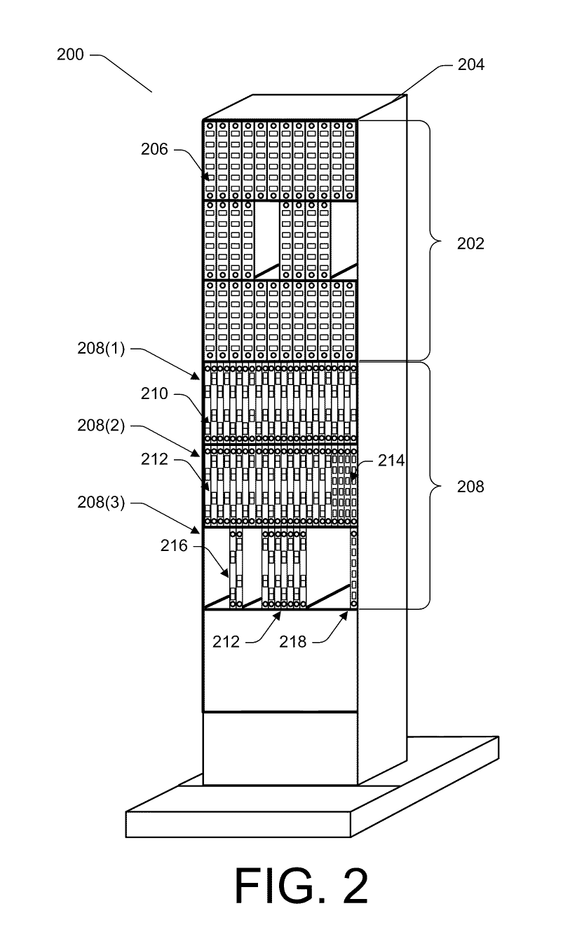

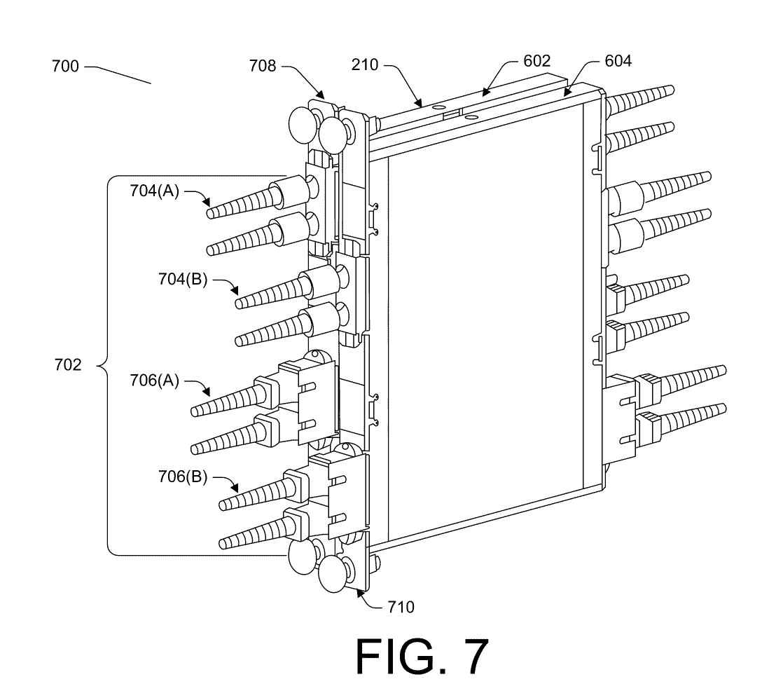

FIG. 2 shows one exemplary implementation of a telecommunications bay 200 for use in telecommunications systems. Bay 200 serves as a central location for connecting multiple telecommunication equipment. Bay 200 is shown populated with low-density modular chassis 202 which are coupled to a telecommunications rack 204. Chassis 202 are in turn populated with low-density splitter modules 206, the splitter modules being located within chassis slots. Bay 200 may also be populated with high-density telecommunications chassis 208, which are coupled to the telecommunications rack 204. One of the high-density chassis 208(1) is in turn populated with high-density splitter modules 210. A second of the high-density telecommunications chassis 208(2), coupled to the telecommunications rack 204 is in turn populated with both an array of mated pairs 212 and an array of high-density patching module 214. Finally, bay 200 may be populated with a high-density telecommunications chassis 208(3), coupled to the telecommunications rack 204 which is in turn partially populated with a mated pair 216 (described in detail in FIG. 7), an array of mated pairs 212, and a high-density patching module 218.

Cables (not shown here) that connect telecommunications equipment run to the bay, and may be coupled to connectors on the front and/or back of the various modules. Telecommunications bay 200 and its accompanying equipment allow for the installation, testing, repairing and monitoring of the connected telecommunications equipment. Often, multiple bays are located in central telephone offices, local exchange offices, or other sites where telecommunications may be routed to and from as discussed in relation to the previous figure. The cables connecting two pieces of equipment are often coupled to one of chassis 202 and 208 so as to allow for one of the inserted modules to connect to the equipment in series. When this configuration is in place, the module may appear “transparent” to the telecommunications network that connects the equipment. That is, data sent between the equipment may pass through the module, but the module will not affect the data signal. With the module in place, however, the module may be used to monitor, test, patch or repair the connected telecommunication equipment. Often, it is common in wireless applications to want to monitor and test signals between telecommunication equipment. For example, a user, or a provider as described above, may want to split a signal from one piece of equipment and test and/or monitor the signal.

### Chassis, Module and Stabilizer

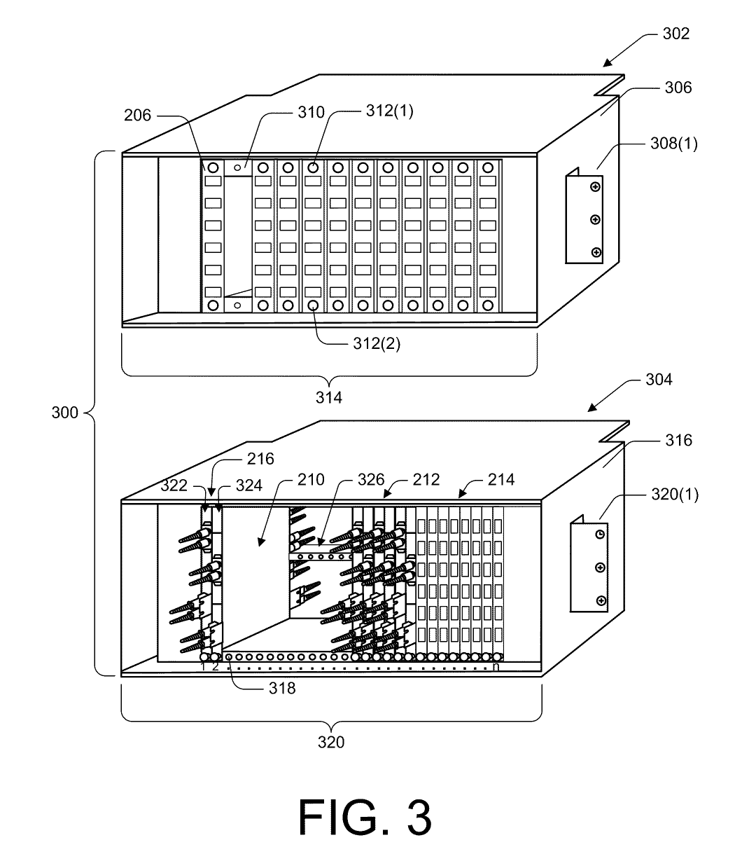

FIG. 3 shows a populated low-density modular chassis 302 currently used in telecommunications systems alongside a high-density modular chassis 304. Low-density modular chassis 302 is for use with a telecommunications bay, such as bay 200. Chassis 302 may include a housing 306, to which two rack attaching plates 308(1) and 308(2) may mount, and are used for connecting the chassis to a rack, such as rack 204. In the chassis of FIG. 3, rack attaching plates utilize bolts for attachment to rack 204, although other connections may also be utilized. The housing defines an area where conventional low-density splitter modules 206 may be placed in the chassis 302. The conventional low-density modular chassis 302 also typically includes chassis slots 310, which help to further define the proper placement of conventional low-density splitter modules 206. After splitter modules 206 are inserted into chassis 302, industry standard front fasteners 312(1) and 312(2) provide the sole means of securing the low-density splitter modules 206 in place. The relatively wide front surfaces (typically about 1.15 inches wide) of the low-density splitter modules 206 provide lateral support to the low-density splitter modules 206 when installed in the chassis 302. Low-density chassis 302 may be configured to receive twelve splitter modules in a standard chassis width 314, such as a chassis designed to fit in a nineteen inch (forty-eight centimeter) wide rack.

High-density modular chassis 304 also includes a housing 316, chassis slots 318, rack attaching plates 320(1) and 320(2), and affords scalability of the quantity of chassis slots 318 via chassis width 320. However, high-density telecommunications chassis 304 is configured to accommodate at least twice as many high-density splitter modules 210 within a given chassis width 320. FIG. 3 illustrates the high-density modular chassis 304 holding a plurality of odd high-density splitter modules 322, even high-density splitter modules 324, mated pairs 216, array of mated pairs 212, and an array of high-density patching modules 214 (described in detail below) rather than the low-density splitter modules 206 of low-density modular chassis 302. Additionally, to stabilize and secure the odd high-density splitter modules 322, even high-density splitter modules 324 and high-density patching modules 214, chassis 304 includes a symmetrical stabilizer 326, which allows the modules 210 to be securely installed to the high-density telecommunications chassis 304 in multiple positions.

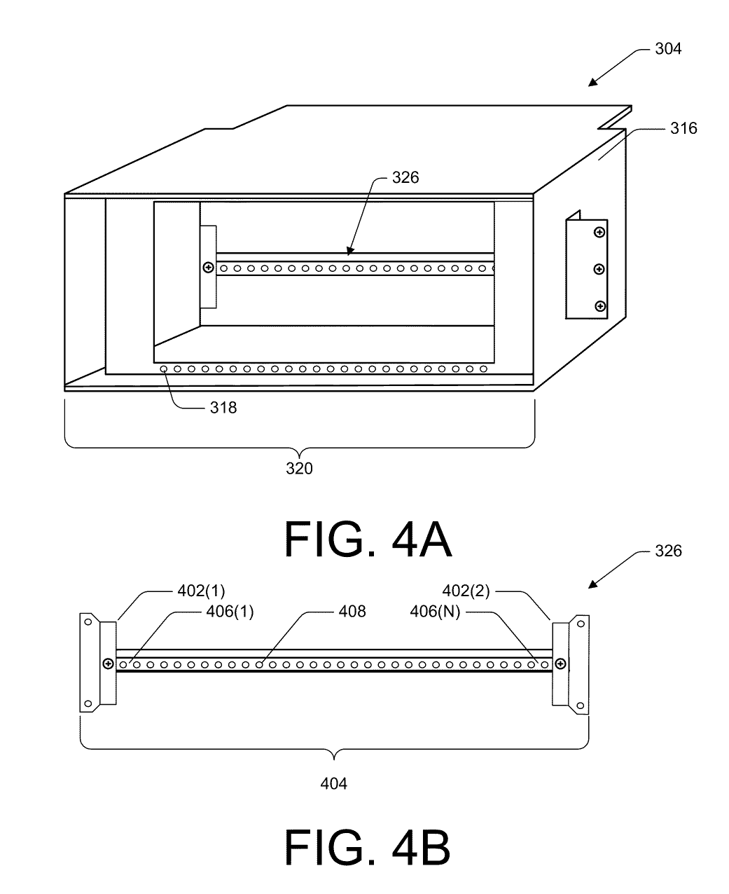

FIG. 4A shows an exemplary implementation of a high-density telecommunications chassis 304 of the present disclosure, including an exemplary implementation of the stabilizer 326. FIG. 4B shows the exemplary stabilizer 326 used to support high-density modules 322, 324, and 214 when installed in the high-density chassis of FIG. 4A, in more detail.

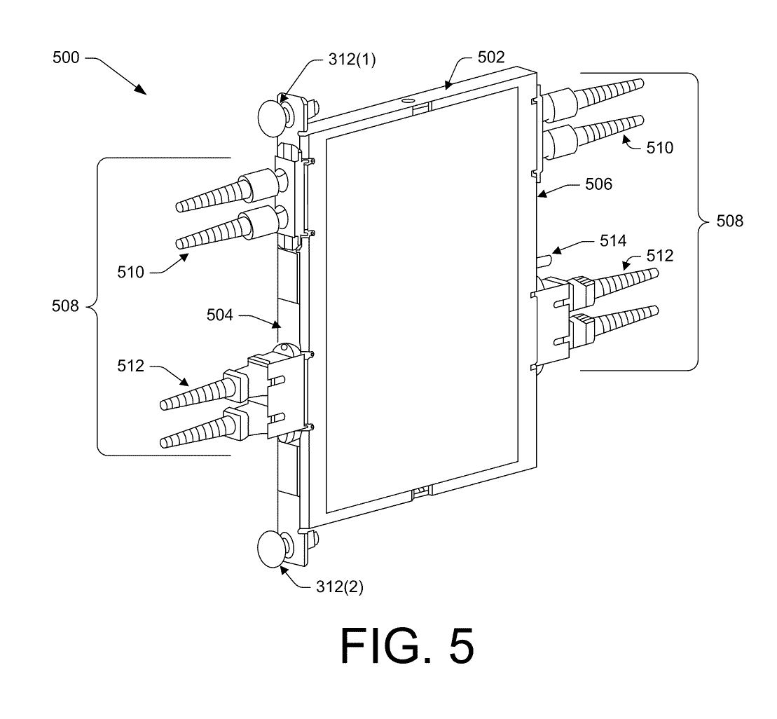

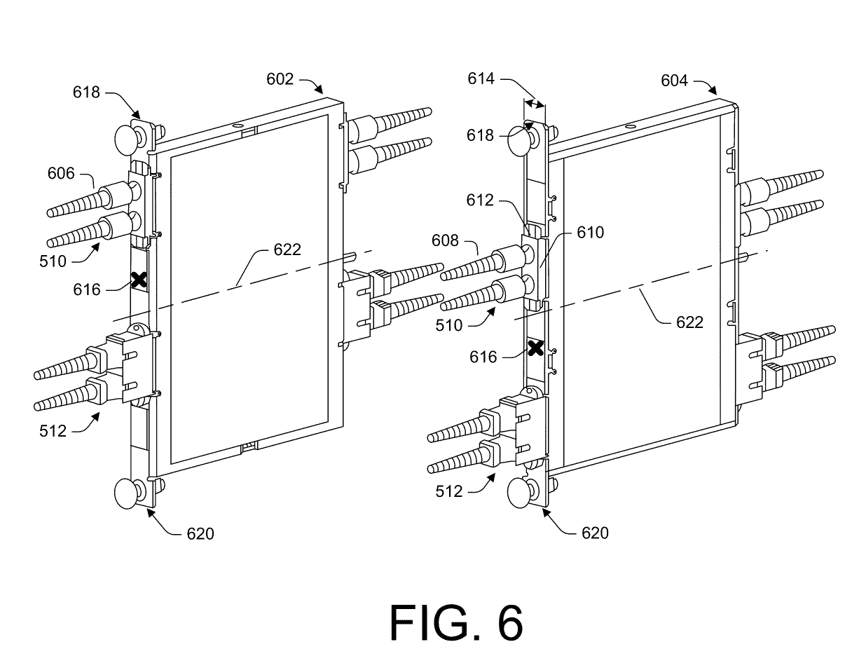

As shown in FIG. 4A, high-density chassis 304 includes a symmetrical stabilization bar 326 spanning a width of the high-density chassis and mounted in the back of high-density chassis. As discussed above, chassis 304 also may include slots 318 which are scalable via chassis width 320. Stabilizer 326 is configured to be disposed on the back surface of housing 316 of chassis 304 via two mounting brackets 402(1) and 402(2), the mounting brackets may utilize bolts for attachment to housing 316, although other connections may also be utilized. Additionally, because stabilizer 326 is symmetric, stabilizer 326 is configured to be disposed on the back surface of the housing 316 without determining a left side, right side, top side or bottom side of the stabilizer 326 to be disposed to a left side or a right side of the housing 316. Stabilizer 326 further comprises a plurality of apertures 408 to receive mounting mechanisms (e.g. pins, shown in FIGS. 5 and 6) disposed on the back surface of the high-density modules. While stabilizer 326 is shown here to comprise a plurality of apertures 408, other features such as slots, vertical grooves, or protrusions may additionally or alternatively be used. Additionally, while stabilizer 326 is shown here to be a symmetric bar spanning the width of the high-density chassis other mechanisms are also possible. For example, a backplane spanning the width of the high-density chassis comprising pins, to be received by the high-density splitter modules 210 is could be used, or any other means for stabilizing the high-density splitter modules 210 installed in a high-density chassis.

Stabilizer 326 is further configured to accommodate the scalability of the quantity of chassis slots 318 via chassis width 320. More specifically, chassis 304 may be configured as a nineteen inch (forty-eight centimeter) wide, 4 rack unit (RU) chassis with a narrow module spacing that allows at least about twenty-four high-density modules to be installed to high-density chassis 304 via the chassis slots 318. A “rack unit” is a unit of standard unit of height equal to about 1.75 inches. Likewise, stabilizer 326 would be configured to accommodate the narrow module spacing to allow at least about twenty-four high-density modules to be installed to the nineteen inch (forty-eight centimeter) wide 4RU high-density chassis via stabilizer length 404. Alternatively, chassis 304 may be configured as a twenty-three inch (fifty-eight centimeter) wide, 4RU chassis with a narrow module spacing that allows thirty-two or more high-density modules to be installed to high-density chassis 304 via the chassis slots 318. Likewise, stabilizer 326 would be configured to accommodate the narrow module spacing to allow thirty-two high-density modules to be installed to the twenty-three inch (58 centimeter) wide 4RU high-density chassis via stabilizer length 404. Accordingly, as width 320 of high-density chassis is scaled, stabilizer width 404 is scaled. Furthermore, as stabilizer width 404 is scaled to match chassis width 320 the array of pin slot position(s) 406(1)-406(N) are also scaled to match the quantity of high-density modules to be installed. For example, if chassis 304 is configured as a nineteen inch (forty-eight centimeter) wide, 4RU chassis with a narrow module spacing that allows at least twenty-four high-density modules to be installed, then the stabilizer 326 is scaled to have an array of at least twenty four pin slot positions to accommodate the twenty-four or more high-density modules.

In one embodiment, the chassis 304 may be a standard 19 chassis and may have a useable width of about 17.5 inches and a height of about 4 rack units (RU) (i.e., about 7 inches). Therefore, the chassis has a useable area of about 7*17.5=122 square inches. In that case, the chassis 304 is designed to receive at least about 19 high-density splitter modules 210. Therefore, a ratio of the number of the high-density splitter modules 210 to the usable area (i.e., a “module density”) of at least about 0.15 modules per square inch is achieved. In the example illustrated in FIG. 3, the chassis 304 may accommodate twenty-eight modules or more, resulting in a module density of 0.23 modules per square inch.

Furthermore, in another embodiment, the chassis 304 may be a standard 23 inch chassis and may have a usable width of 21.5 inches and a height of about 4RU (i.e., about 7 inches). Therefore, the useable area has about 7*21.5=150.5 square inches. In that case, the chassis 304 may have a module density of about 0.22 modules per square inch. In still other embodiments, further increases in module density may be achieved by further decreasing the width of each module.

FIGS. 5-7 depict an exemplary implementation of high-density splitter modules 500. High-density splitter modules 500 include a symmetrical housing 502, which has electrical components mounted therein, a font surface 504 and a back surface 506. The module 500 also includes one or more adapters 508, generally formed vertically on the front surface 504 and back surface 506 as shown in FIG. 5. The adapters 508 may include, for example, simplex SC adapters, duplex SC adapters and FC adapters. In some implementations, high-density splitter module 500 will have a first pair of adapters 510, and a second pair of adapters 512 disposed on the front surface 504 and back surface 506. The adapters 508 may be disposed in an adapter array and each adapter may provide for input signals. For example, each splitter module 500 may be configured to receive 4 input signals via the adapters 508 on the front surface 504. More specifically, as shown in FIG. 6, odd high-density splitter module 602 and even high-density splitter module 604 include odd adapter array 606 disposed on symmetrical housing 502 and even adapter array 608 disposed on symmetrical housing 502, respectively. That is, in some implementations, the odd and even splitter modules 500 may employ identical housings that are simply flipped vertically relative to one another. Although odd high-density splitter module 602 and even high-density splitter module 604 may comprise identical symmetrical housing 502, the internal electrical components are unique to both the odd high-density splitter module 602 and even high-density splitter module 604. Alternatively, the housings 502 of the odd and even splitter modules may be different.

As shown in FIG. 5, both odd adapter array and even adapter array comprise a pair of adapters 510 spaced a distance (e.g., about 1.5 inches) apart from another pair of adapters 512. While the space between adapters 510 and 512 enables access to the adapters 510 and 512, the space between adapters 510 and 512 as well as the space below adapter 512 may additionally allow for labels that may designate adapters 510 and/or 512. Additionally, the same label space on the front surface 504 of the module 500 is also available on the back surface 506 of module 500. Each of the adapters 510 and 512 disposed on the front surface of the odd and even modules comprise longitudinal edges 610 and latitudinal edges 612. The longitudinal edges 610 are vertically arranged along the front surface of the even module 604 and are longer than the latitudinal edges 612, and the latitudinal edges 612 are shorter than the front surface width 614 (i.e. at most about 0.5 inches (1.3 centimeters)) of the of the odd and even modules. Furthermore, the adapters 510 and 512 comprise a surface area portion extending from the longitudinal edges 610 of both sides of the adapters 510 and 512, such that the surface area portions are disposed against both walls inside of the symmetrical housing 502. With a surface area portion of adapters 510 and 512 sandwiched between the inside walls of the symmetrical housing 502, this enables a robust connection of adapters 510 and 512 to both the front surface 504 and the back surface 506 as well as providing torsional support for the adapters 510 and 512.

Finally, both arrays comprise a midpoint 616 that is located an equal distance from adapters 510 and adapters 512. As FIG. 6 shows, midpoint 616 of odd adapter array 606 is disposed closer to the top edge 618 than to bottom edge 620 of front surface 504, and midpoint 616 of even adapter array 608 is disposed closer to the bottom edge 620 than to top edge 618 of front surface of 504. In other words, the odd adapter array is vertically off-center of a vertical centerline 622 of each module, such that the odd array is disposed closer to the top edge 618 than to the bottom edge 620, and even adapter array is vertically off-center of centerline 622 such that the even array is disposed closer to the bottom edge 620 than to the top edge 618. Although certain axis have been described herein as being “vertical” and “horizontal” axes, in practice, the relative directions of the axes may be rotated (e.g., the chassis could be rotated and all the modules in it).

Referring now back to FIG. 5, high-density splitter modules 500 also include front fasteners 312(1) and 312(2). The front fasteners 312 lock the high-density splitter modules in place to a high-density chassis via chassis slots 318. Finally, high-density splitter modules 500 each include a mounting mechanism, such as pin 514, that is configured to be received by a complimentary mounting mechanism on the stabilizer 326, such as the pin slot position(s) 406(1)-406(N) of the stabilizer 326. When pin 514 is received by any of the pin slot position(s) 406(1)-406(N) of the stabilizer the pin fixes the high-density module in location resulting in a rigid installation. Because of front surface 504 being configured to support narrow module spacing of the high-density chassis (i.e. a front surface 504 having width 614 that is about 0.5 inches (1.3 centimeters)), front surface 504 provides less lateral support than the wider, low-density splitter modules 206 of FIG. 3. In combination pin 514 and stabilizer 326 directly operate to provide the rigid installation of high-density splitter modules 500 in high-density chassis 304. While pin 514 is shown here to be a pointed cylindrical protrusion, other pin shapes, such as a rectangular bar protrusion are also possible. Additionally, is should be appreciated that while pin 514 is shown here to be disposed on the high-density splitter modules 500, alternatively, the pin 514 could be disposed on a backplane spanning the width of the high-density chassis, or the pin may be disposed on the stabilizer 326. In either configuration, the pin disposed on a backplane or stabilizer 326 would be received by the high-density splitter modules 500. Alternatively, the high-density splitter module 500 mounting mechanism may be a slender elongated bar mounted vertically on the back surface of the high-density splitter modules 500. In that case, the slender elongated bar would be received by and mated to a slender elongated slot disposed in the stabilizer 326. Likewise, the slender elongated bar of the high-density splitter module 500 may be received by a slot disposed on a backplane spanning the width of the high-density chassis.

FIG. 7 depicts an exemplary implementation of a mated pair 700 of high-density splitter modules 210. Mated pair 700 includes an odd high-density splitter module 602 directly adjacent to even high-density splitter module 604 and, as described above, respectively include odd adapter array 606 and even adapter array 608. Mated pair 700 further includes an array of adapters 702. Specifically, the array of adapters 702 includes odd adapter array 606 and even adapter array 608 such that adapters 704(A) and 704(B), and adapters 706(A) and 706(B) are configured in positions generally formed vertically along the front surface of the high-density splitter modules as shown in FIG. 7. This arrangement provides individual access and clearance (both vertically and laterally) around each adapter 704(A), 704(B), 706(A) and 706(B) when installed adjacently in a high-density chassis 304.

Because odd adapter array 606 positions adapters 704(A) and adapters 706(A) closer to top edge 708 and even adapter array 608 positions adapters 704(B) and adapters 706(B) closer to bottom edge 710 is the adapters are staggered with respect to each other when odd and even high-density splitter modules are positioned directly adjacent each other as a mated pair 700. That is, adapter 704(A) does not reside directly next to adapter 704(B) and likewise adapter 706(A) does not reside directly next to adapter 706(B). This array of staggered adapters 702 provides a user with about 0.5 inch (1.3 centimeters) of finger access on both sides of the adapters. Therefore, after the high-density splitter modules are installed in a high-density telecommunications chassis each adapter remains accessible by a user.

While an array of adapters 702 represents one way that high-density modules may be installed in a high-density telecommunications chassis, multiple other installation techniques may be utilized. While the above examples are illustrative, it should be apparent that a wide variety of examples of installation mechanisms are contemplated to secure a high-density module to a high-density telecommunications chassis in an array of positions.

### Exemplary High-Density Module Installation

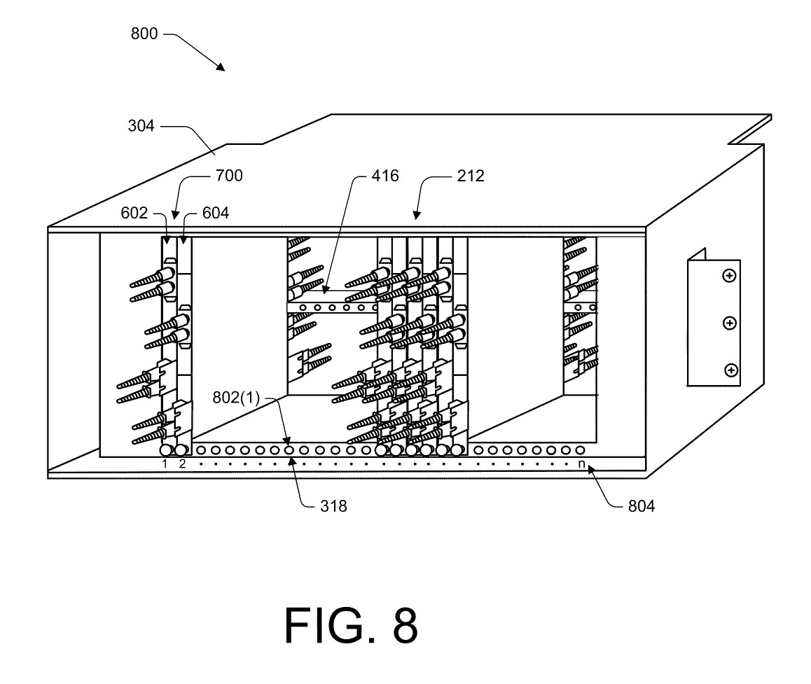

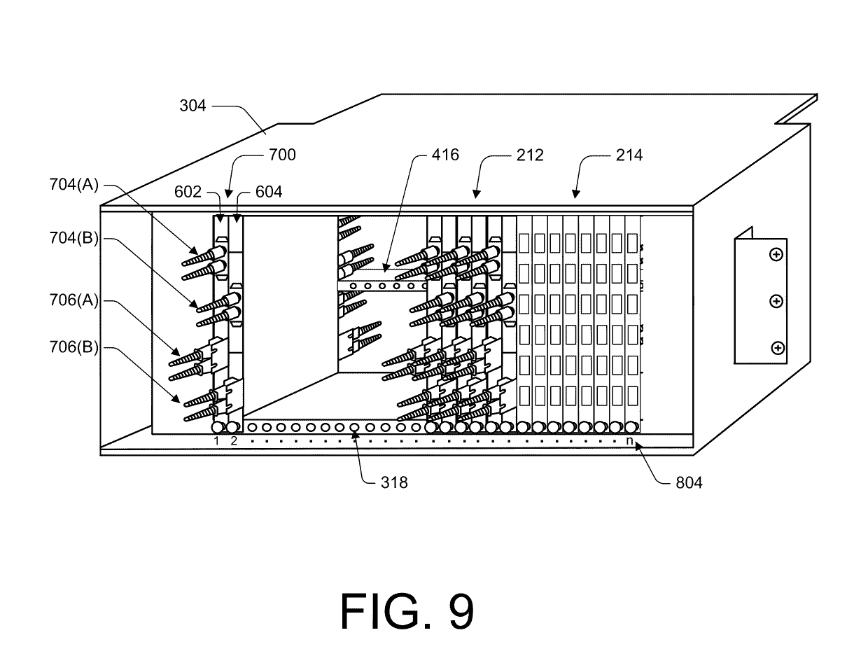

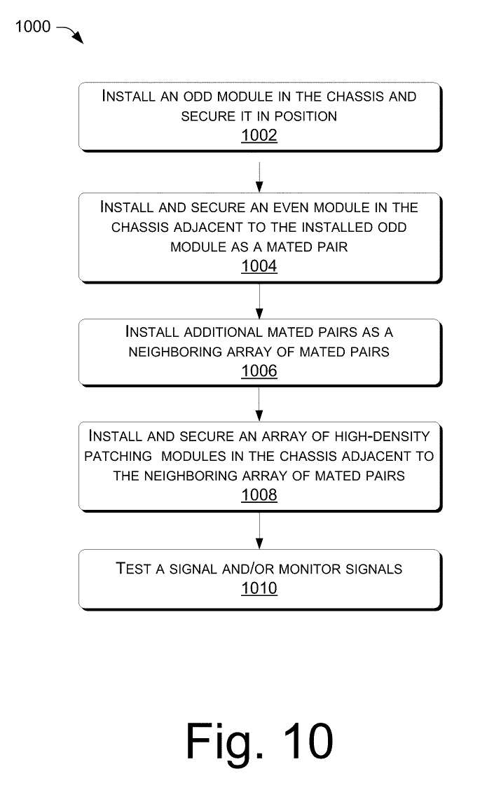

In combination, high-density telecommunications chassis 304, odd high-density splitter module 602, even high-density splitter module 604, high-density patching modules 214 and stabilizer 416 directly operate to secure the high-density modules to the chassis in multiple positions. FIGS. 8 and 9 show the high-density modules in exemplary secured positions in the high-density telecommunications chassis, while FIG. 10 shows a flowchart of an exemplary method of using the described system. Accordingly, the following discussion will reference each of these figures.

Odd high-density splitter module 602 may initially be inserted into chassis 304 via chassis slots 318. Chassis slots 318 may include fastening holes 802(1) and 802(2) configured to fasten to front fasteners 312(1) and 312(2) disposed on the high-density splitter modules and high-density patching modules. The module may also be installed into the appropriate location with the help of a label 804 below chassis slots 318 that indicate a column number (e.g. 1, 2, . . . n, as shown in FIG. 8) for each chassis slot 318. As an odd high-density splitter module 602 is inserted into the chassis, the odd high-density splitter module may insert pin 514 disposed on the back surface 506 of odd high-density splitter module 602 into one of the apertures of pin slot position(s) 416(1)-416(N) disposed in stabilizer 326, thereby connecting the odd high-density splitter module 602 with stabilizer 326. Odd high-density splitter module 602 may then be locked in place via the industry standard front fasteners 312(1) and 312(2) by way of fastening holes 802(1) and 802(2). This in turn keeps the odd high-density splitter module fixed in location and results in a rigid installation. Even high-density splitter module 604 may then be inserted into chassis 400 directly next to odd high-density splitter module 602 in a similar manner as odd high-density module 602. Even high-density splitter module 604 installed directly next to odd high-density splitter module 602 defines a mated pair 700 as described in FIG. 7.

Additionally, as shown in FIG. 8, high-density telecommunications chassis 304 may be populated with an array of mated pairs 212. The neighboring array of mated pairs 212 including more than one mated pair 700. As shown in FIG. 8 three mated pairs are positioned adjacent each other comprising the array of mated pairs 212.

FIG. 9 depicts, a mated pair 700 comprising both odd and even high-density modules 602 and 604, respectively, an array of mated pairs 212, and an array of high-density patching modules 214 installed in the high-density telecommunications chassis 304. As FIG. 9 depicts, the high-density telecommunications chassis 304 may be partially populated with high-density modules in an array of positions. However, high-density telecommunications chassis 304 may be fully populated (i.e., all chassis slots 318 being occupied by high-density modules). Additionally, it should be appreciated that regardless of how the high-density telecommunications chassis 304 may be populated, each adapter disposed on the high-density modules remain accessible. For example, if high-density telecommunications chassis 304 is populated such that a neighboring array of mated pairs 212 are positioned directly adjacent to an array of high-density patching modules 214, adapters 704(A), 704(B), 706(A) and 706(B) remain accessible as described with respect to FIG. 7.

FIG. 10 is a flow diagram of an example process 1000 for installing and using a high-density telecommunications patch/splitter system. In some instances, this process begins at operation 1002 with the installation of an odd high-density splitter module in a high-density telecommunications chassis, where the odd high-density splitter module is secured in a chassis slot position via front fasteners.

Process 1000 includes installing and securing, at operation 1004, an even high-density splitter module in the high-density telecommunications chassis adjacent to the installed odd high-density splitter module as a matted pair.

Next, operation 1006 represents installing additional mated pairs as an array of mated pairs. For instance, half of the high-density telecommunications chassis may be populated with the array of mated pairs.

At operation 1008, any number of high-density patching modules may be installed in the high-density telecommunications chassis. For example, in this process 1000, the remaining half of the high-density telecommunications chassis may be populated with the array of high-density patching modules adjacent to the array of mated pairs. Finally, operation 1010 represents splitting, monitoring and testing of optical signals of high-density optical distribution equipment of a telecommunications system via the accessible adapters disposed on the high-density modules.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A high-density telecommunications patch/splitter system comprising:
a high-density telecommunications chassis configured to receive a plurality of high-density modules;
a plurality of high density modules disposed in the chassis, each of the modules being coupled to the chassis at a front surface of the modules, and each module having a mounting mechanism disposed on a back surface of the module; and
a stabilizer coupled to a back of the chassis and engaging the mounting mechanism disposed on the back surface of each module to stabilize the modules in the chassis.

2. The high-density telecommunications patch/splitter system of claim 1, wherein the system has a density of at least about 0.15 modules per square inch.

3. The high-density telecommunications patch/splitter system of claim 2, wherein the system has at least about 4 input signals per module.

4. The high-density telecommunications patch/splitter system of claim 1, wherein the front surface of the modules coupled to the chassis is about 0.5 inches (1.3 centimeters) in width.

5. The high-density telecommunications patch/splitter system of claim 4, wherein the chassis is about 4 rack units (RUs) in height and about nineteen inches (forty-eight centimeters) in width, and is configured to receive at least nineteen of the modules.

6. The high-density telecommunications patch/splitter system of claim 4, wherein the chassis is about 4 rack units (RUs) in height and about twenty-three inches (fifty-eight centimeters) in width, and is configured to receive at least twenty-eight of the modules.

7. The high-density telecommunications patch/splitter system of claim 1, wherein the stabilizer comprises a bar spanning a width of the chassis and having a complimentary feature to engage the mounting mechanism on the back surface of each of the modules.

8. The high-density telecommunications patch/splitter system of claim 7, wherein the mounting mechanism disposed on the back surface of the module comprises a pin and the complimentary feature on the stabilizer comprises an aperture to receive the pin.

9. The high-density telecommunications patch/splitter system of claim 1, wherein the plurality of high density modules disposed in the chassis comprises:
(i) an odd high-density module with an odd adapter array disposed on the front surface of the odd high-density module, the odd adapter array having an adapter spaced a distance apart from another adapter and wherein the odd adapter array is disposed closer to a top edge of the front surface than to a bottom edge of the front surface;
(ii) an even high-density module with an even adapter array disposed on the front surface of the even high-density module, the even adapter array having an adapter spaced a distance apart from another adapter and wherein the even adapter array is disposed closer to a bottom edge of the front surface than to a top edge of the front surface.

10. The high-density telecommunications patch/splitter system of claim 9, wherein the odd high-density module and the even high-density module are disposed in the chassis directly adjacent to each other as a mated pair configured to provide individual access to each of the adapters.

11. The high-density telecommunications patch/splitter system of claim 9, wherein multiple odd high-density modules and multiple even high-density modules are alternatingly disposed in the chassis directly adjacent to each other as an array of mated pairs configured to provide individual access to each of the adapters.

12. A high-density telecommunications splitter module comprising:
a module housing with a front surface and a back surface opposite the front surface, wherein the front surface comprises a top edge and a bottom edge located opposite the top edge;
an adapter array disposed on the front surface, the adapter array comprising an adapter spaced a distance apart from another adapter and wherein the adapter array is vertically offcenter toward either the top edge of the front surface or the bottom edge of the front surface; and
front surface couplings for coupling the splitter module front surface to a front surface of a housing.

13. The high-density splitter module of claim 12, wherein the front surface of the module housing is about 0.5 inch (1.3 centimeters) wide.

14. The high-density splitter module of claim 13, wherein the adapters disposed on the front surface comprise longitudinal edges and latitudinal edges, the longitudinal edges being longer than the latitudinal edges and the latitudinal edges being shorter than the front surface width of the modules; and
wherein the longitudinal edges are arranged vertically along the front surface of the modules.

15. The high-density splitter module of claim 12, wherein each of the adapters in the adapter array comprises a pair of adapters, and wherein each pair of adapters is spaced a distance apart from the other pair of adapters.

16. The high-density splitter module of claim 15, wherein the pair of adapters comprises a type of adapter and the other pair of adapters comprises a different type of adapter.

17. The high-density splitter module of claim 12, wherein the module comprises a mounting mechanism disposed on the back surface opposite the front surface for engaging a stabilizer coupled to a back of a chassis to stabilize the module in the chassis.

18. The high-density splitter module of claim 17, wherein the mounting mechanism comprises a pin and wherein the stabilizer includes an aperture to receive the pin to stabilize the module in the chassis.

19. The high-density splitter module of claim 12, wherein each of the adapters disposed on the front surface comprises:
a duplex standard connector (SC) adapters;
a simplex standard connector (SC) adapters; or
a ferrule connector (FC) adapters.

20. The high-density splitter module of claim 12, wherein the front surface couplings comprise push/snap fasteners.

21. The high-density splitter module of claim 12, wherein the adapters are disposed in slots in the housing, the adapters having substantially planar sidewalls disposed directly adjacent sidewalls of the housing, such that the adapters are sandwiched between inside surfaces of the housing sidewalls.

22. A high-density telecommunications mated pair comprising:
an odd high-density module comprising an odd adapter array, the odd high-density module configured to install in a high-density telecommunications chassis and be securely positioned directly adjacent to an even high-density module in the chassis; and
an even high-density module comprising an even adapter array, the even high-density module configured to install in the high-density telecommunications chassis and to be securely positioned directly adjacent to the odd high-density module in the chassis,
wherein the odd adapter array of the odd high-density module is offset vertically relative to the even adapter array of the even high-density module.

23. The high-density telecommunications mated pair of claim 22, wherein the odd high-density module and the even high-density module each comprise a front surface opposite a back surface, the front surface being about 0.5 inch (1.3 centimeters) wide.

24. The high-density telecommunications mated pair of claim 22, wherein the odd high-density module and the even high-density module each comprise a mounting mechanism disposed on a back surface of the respective high-density module for engaging a stabilizer coupled to a back of a chassis to stabilize the high-density module in the chassis.

25. The high-density telecommunications mated pair of claim 22, wherein the odd adapter array and the even adapter array each comprise a pair of adapters spaced a distance apart from another pair of adapters and arranged vertically along a front surface of each of the odd module and of the even module.

26. A high-density telecommunications module comprising:
a first sidewall and a second sidewall coupled together to form a housing of the high-density telecommunications module, the housing including a plurality of slots to receive telecommunication adapters; and
a plurality of telecommunication adapters disposed in the slots, the plurality of adapters having substantially planar sidewalls disposed directly adjacent the first and second sidewalls, such that the telecommunication adapters are sandwiched between inside surfaces of the first and second sidewalls.
